(19) United States
(12) Patent Application Publication
(10) Pub. No.: US 2024/0150913 A1
(43) Pub. Date: May 9, 2024

(54) FUEL ELECTRODE FOR SOLID OXIDE ELECTROLYSIS CELL WITH IMPROVED HIGH-TEMPERATURE ELECTROLYSIS EFFICIENCY AND METHOD OF MANUFACTURING SAME

(71) Applicants: HYUNDAI MOTOR COMPANY, SEOUL (KR); KIA CORPORATION, SEOUL (KR); UIF (UNIVERSITY INDUSTRY FOUNDATION), YONSEI UNIVERSITY, SEOUL (KR)

(72) Inventors: Si Won Kim, Gunpo-si (KR); Ji Hoon Jang, Suwon-si (KR); Jong Sup Hong, Seoul (KR); Hwi Tae Kim, Seoul (KR)

(21) Appl. No.: 18/229,807

(22) Filed: Aug. 3, 2023

(30) Foreign Application Priority Data
Nov. 9, 2022 (KR) 10-2022-0148794

(51) Int. Cl. C25B 11/067; C25B 11/091

(52) U.S. Cl. CPC C25B 11/067; C25B 11/091

(57) ABSTRACT

A fuel electrode for a solid oxide electrolysis cell (SOEC) with improved high-temperature electrolysis efficiency includes a carrier having a first particle including nickel, and a second particle comprising yttria-stabilized zirconia, and a catalyst having a first element including at least one selected from the group consisting of Fe, Co, Pd, Cu, Mo, and combinations thereof, and a second element comprising gadolinia-doped ceria.

### CROSS REFERENCE TO RELATED APPLICATIONS

The present application claims priority to Korean Patent Application No. 10-2022-0148794, filed Nov. 9, 2022, the entire contents of which is incorporated herein for all purposes by this reference.

### BACKGROUND

### 1. Field of the Disclosure

The present disclosure relates to a fuel electrode for a solid oxide electrolysis cell with improved high-temperature electrolysis efficiency and to a method of manufacturing the same.

### 2. Description of the Related Art

Among green methods for hydrogen production, solid oxide electrolysis cells (SOECs) have advantages of high efficiency and low operating voltage compared to polymer electrolyte membrane (PEM) electrolysis cells and alkaline electrolysis cells.

However, the currently available SOECs use the elements of the existing solid oxide fuel cells and thus have problems of insufficient performance and durability deterioration due to the lack of dedicated materials. Particularly, the existing Ni-yttria-stabilized zirconia (YSZ)-based fuel electrodes have a problem of having poor stability due to nickel degradation.

### SUMMARY

An objective of the present disclosure is to provide a fuel electrode for a solid oxide electrolysis cell with improved high-temperature electrolysis efficiency and a method of manufacturing the same.

Objectives of the present disclosure are not limited to the objectives mentioned above. The above and other objectives of the present disclosure will become more apparent from the following description, and will be realized by the means of the appended claims, and combinations thereof.

According to one embodiment of the present disclosure, a fuel electrode for a solid oxide electrolysis cell includes a carrier including a first particle containing nickel (Ni) and a second particle containing yttria-stabilized zirconia (YSZ), and a catalyst including a first element including at least one selected from the group consisting of Fe, Co, Pd, Cu, Mo, and combinations thereof and a second element including gadolinia-doped ceria (GDC), in which the catalyst is supported on the carrier, and at least a portion of the first element forms an alloy with the first particle on a surface of the first particle.

The first particle may have a diameter of 1.5 μm or less.

The second particle may have a diameter of 350 nm to 500 nm.

The catalyst may have a diameter of 20 nm to 60 nm.

According to one embodiment of the present disclosure, a method of manufacturing a fuel electrode for a solid oxide electrolysis cell includes preparing a carrier including a first particle containing nickel (Ni) and a second particle containing yttria-stabilized zirconia (YSZ), obtaining a first intermediate by injecting a precursor of a first element into the carrier and by performing a first heat treatment, wherein the first element includes at least one selected from the group consisting of Fe, Co, Pd, Cu, Mo, and combinations thereof, obtaining a second intermediate by injecting a precursor of a second element into the first intermediate and by performing a second heat treatment, wherein the second element includes gadolinia-doped ceria (GDC), and obtaining a fuel electrode by reducing the second intermediate product under a hydrogen atmosphere.

The method may further include performing heat treatment on the carrier before injecting the precursor of the first element into the carrier.

A first solution including the precursor of the first element, a chelating agent, and a mixed solvent of a water-based solvent and an alcohol-based solvent may be injected into the carrier.

A mole ratio of cations in the precursor of the first element to the chelating agent may be in a range of about 1 to 10.

The chelating agent may include at least one selected from the group consisting of urea, glycine, Triton X, citric acid, and combinations thereof.

The precursor of the first element may be injected in an amount range of about 2.25 mg/cm² to 2.75 mg/cm².

The first heat treatment may be performed by heating at a temperature in a range of about 50° C. to 100° C. for about 1 hour to 3 hours, in a range of about 120° C. to 200° C. for about 1 hour to 2 hours, and in a range of about 300° C. to 500° C. for about 1 hour to 3 hours, and the first heat treatment may be performed at least one time.

A second solution including the precursor of the second element, a chelating agent, and a mixed solvent of a water-based solvent and an alcohol-based solvent may be injected into the first intermediate.

A mole ratio of cations in the precursor of the second element to the chelating agent may be in a range of about 1 to 10.

The precursor of the second element may be injected in an amount range of about 81 mg/cm² to 87 mg/cm².

The second heat treatment may be performed by heating at a temperature in a range of about 50° C. to 100° C. for about 1 hour to 3 hours, in a range of about 120° C. to 200° C. for about 1 hour to 2 hours, and in a range of about 300° C. to 500° C. for about 1 hour to 3 hours, and the second heat treatment may be performed at least one time.

The second intermediate may be reduced under a hydrogen atmosphere at a temperature range of about 750° C. to 800° C. to obtain the fuel electrode.

According to the present disclosure, a fuel electrode for a solid oxide electrolysis cell with improved high-temperature electrolysis efficiency and a method of manufacturing the same can be obtained.

Effects of the present disclosure are not limited to the effects mentioned above. It should be understood that the effects of the present disclosure include all effects which can be deduced from the following description.

### BRIEF DESCRIPTION OF THE FIGURES

FIG. 1 shows a carrier according to an embodiment of the present disclosure;

FIG. 2 shows a fuel electrode according to an embodiment of the present disclosure;

FIG. 3 shows analysis results of a fuel electrode manufactured according to Preparation Example 1, the analysis performed with a scanning electron microscope (SEM);

FIG. 4 shows polarization resistance measurement results of fuel electrodes manufactured according to Preparation Example 1 (Fe-GDC), Preparation Example 2 (Co-GDC), Comparative Preparation Example 1 (Reference), and Comparative Preparation Example 2 (GDC);

FIG. 5A shows performance evaluation results of fuel electrodes manufactured according to Comparative Preparation Example 1 (Reference).

FIG. 5B shows performance evaluation results of fuel electrodes manufactured according to Comparative Preparation Example 4 (Fe).

FIG. 5C shows performance evaluation results of fuel electrodes manufactured according to Comparative Preparation Example 2 (GDC).

FIG. 5D shows performance evaluation results of fuel electrodes manufactured according to Preparation Example 1 (Fe-GDC).

FIG. 6 shows Performance of each of the fuel electrodes manufactured according to Preparation Example 1 (Fe-GDC), Comparative Preparation Example 1 (Reference), Comparative Preparation Example 2 (GDC), and Comparative Preparation Example 4 (Fe).

### DETAILED DESCRIPTION

Above objectives, other objectives, features, and advantages of the present disclosure will be readily understood from the following preferred embodiments associated with the accompanying drawings. However, the present disclosure is not limited to the embodiments described herein and may be embodied in other forms. The embodiments described herein are provided so that the disclosure can be made thorough and complete and that the spirit of the present disclosure can be fully conveyed to those skilled in the art. Throughout the drawings, like elements are denoted by like reference numerals. In the accompanying drawings, the dimensions of the structures are larger than actual sizes for clarity of the present disclosure.

Terms used in the specification, “first”, “second”, etc., may be used to describe various components, but the components are not to be construed as being limited to the terms. These terms are used only for the purpose of distinguishing a component from another component. For example, without departing from the scope of the present disclosure, a first component may be referred as a second component, and a second component may be also referred to as a first component. The singular expression includes the plural expression unless the context clearly indicates otherwise.

It will be further understood that the terms “comprises”, “includes”, or “has” when used in this specification specify the presence of stated features, regions, integers, steps, operations, elements and/or components, but do not preclude the presence or addition of one or more other features, regions, integers, steps, operations, elements, components and/or combinations thereof. It will also be understood that when an element such as a layer, film, area, or sheet is referred to as being “on” another element, it can be directly on the other element, or intervening elements may be present therebetween. Similarly, when an element such as a layer, film, area, or sheet is referred to as being “under” another element, it can be directly under the other element, or intervening elements may be present therebetween.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated.

A solid oxide electrolysis cell may include a porous fuel electrode, a dense electrolyte air electrode, and a porous air electrode. When water vapor flows into a fuel channel as a reactant, and a voltage is applied to the fuel electrode, a water vapor decomposition reaction occurs. Half-reactions occurring at the fuel electrode and the air electrode and an overall reaction are as follows.

Half-reaction occurring at fuel electrode: H₂O+2e⁻→H₂+O²⁻

Half-reaction occurring at air electrode: O²⁻→1/2O₂+2e⁻

Overall reaction: H₂O→H₂+1/2O₂

According to one embodiment of the present disclosure, a method of manufacturing a fuel electrode for a solid oxide electrolysis cell includes preparing a carrier including a first particle containing nickel (Ni) and a second particle containing yttria-stabilized zirconia (YSZ), obtaining a first intermediate by injecting a precursor of a first element into the carrier and by performing a first heat treatment, wherein the first element may include at least one selected from the group consisting of Fe, Co, Pd, Cu, Mo, and combinations thereof, obtaining a second intermediate by injecting a precursor of a second element into the first intermediate and by performing a second heat treatment, wherein the second element may include including gadolinia-doped ceria (GDC), and obtaining a fuel electrode by reducing the second intermediate under a hydrogen atmosphere.

A method of preparing the carrier is not particularly limited, and the carrier may be prepared by conventionally known methods. For example, the carrier may be prepared by spray-drying a mixed solution, obtained by mixing nickel oxide (NiO), yttria-stabilized zirconia (YSZ), and a solvent, to obtain powder and by applying pressure to the powder or preparing a slurry from the powder for tape casting.

In addition, the solid oxide electrolysis cell itself may be prepared by laminating the electrolyte, the air electrode, and the like on the carrier.

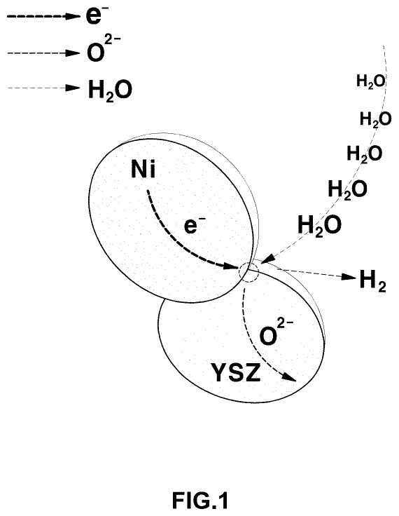

FIG. 1 shows the carrier according to an embodiment of the present disclosure.

The first particle containing nickel (Ni) may have electronic conductivity. The first particle may have a size of about 1 μm or less. In this case, the size may mean a diameter thereof. The lower limit of the size of the first particle is not particularly limited, and may be 100 nm or more, 300 nm or more, 500 nm or more, or 700 nm or more.

The second particle containing YSZ may have oxygen ion conductivity. The second particle may have a size in a range of about 350 nm to 500 nm.

The carrier may be in a state where the first particle and second particle are mixed with each other.

The method according to the present disclosure may further include performing heat treatment on the carrier before injecting the precursor of the first element into the carrier. For example, the heat treatment may be performed on the carrier at a temperature range of about 300° C. to 500° C.

When injecting a first solution including the precursor of the first element, a chelating agent, and a mixed solvent of a water-based solvent and an alcohol-based solvent into the carrier, the precursor of the first element may be infiltrated into pores of the carrier.

The first element is one component of the catalyst and may include at least one selected from the group consisting of Fe, Co, Pd, Cu, Mo, and combinations thereof.

The precursor of the first element may include a nitrate, an acetic compound, or a chloride compound of the first element.

The precursor of the first element may be injected in an amount range of about 2.25 mg/cm² to 2.75 mg/cm².

The chelating agent may include at least one selected from the group consisting of urea, glycine, Triton X, citric acid, and combinations thereof.

An injection amount of the chelating agent is not particularly limited. For example, a mole ratio of cations in the precursor of the first element to the chelating agent may be in a range of about 1 to 10.

A volume ratio of the water-based solvent to the alcohol-based solvent included in the mixed solvent may be in a range of about 1:1 to 1:3.

The first solution may be prepared by dissolving the precursor of the first element into the water-based solvent, injecting the chelating agent, and adding the alcohol-based solvent thereto.

The first solution may be injected into the carrier and then, the first heat treatment may be performed on the resulting solution to obtain the first intermediate in which an oxide of the first element is supported on the carrier.

The first heat treatment may be performed by heating at a temperature in a range of about 50° C. to 100° C. for about 1 hour to 3 hours, in a range of about 120° C. to 200° C. for about 1 hour to 2 hours, and in a range of about 300° C. to 500° C. for about 1 hour to 3 hours.

The first heat treatment may be performed at least one time.

The precursor of the first element is infiltrated into the pores of the carrier by injecting the first solution into the carrier. Then, when the resulting solution is heated at a temperature range of about 50° C. to 100° C., the chelating agent is decomposed, and the precursor of the first element is precipitated on the carrier. When the temperature is raised to about 300° C. to 500° C. through about 120° C. to 200° C., the precursor of the first element is supported on the carrier in the form of the oxide.

When injecting a second solution including the precursor of the second element, a chelating agent, and a mixed solvent of a water-based solvent and an alcohol-based solvent into the first intermediate, the precursor of the second element may be infiltrated into the pores of the carrier.

The second element is one component of the catalyst and may include gadolinia-doped ceria (GDC).

The precursor of the second element may include a nitrate, an acetic compound, or a chloride compound of gadolinium (Gd) and cerium (Ce).

The precursor of the second element may be injected in an amount range of about 81 mg/cm² to 87 mg/cm².

The chelating agent may include at least one selected from the group consisting of urea, glycine, Triton X, citric acid, and combinations thereof.

An injection amount of the chelating agent is not particularly limited. For example, a mole ratio of cations in the precursor of the second element to the chelating agent may be in a range of about 1 to 10.

A volume ratio of the water-based solvent and the alcohol-based solvent included in the mixed solvent may be in a range of about 1:1 to 1:3.

The second solution may be prepared by dissolving the precursor of the second element into the water-based solvent, injecting the chelating agent, and adding the alcohol-based solvent thereto.

The second solution may be injected into the carrier and then, the second heat treatment may be performed on the resulting solution to obtain the second intermediate in which the second element and the oxide of the first element are supported on the carrier.

The second heat treatment may be performed by heating at a temperature in a range of about 50° C. to 100° C. for about 1 hour to 3 hours, in a range of about 120° C. to 200° C. for about 1 hour to 2 hours, and in a range of about 300° C. to 500° C. for about 1 hour to 3 hours.

The second heat treatment may be performed at least one time.

The precursor of the second element is infiltrated into the pores of the carrier by injecting the second solution into the carrier. Then, when the resulting solution is heated at a temperature range of about 50° C. to 100° C., the chelating agent is decomposed, and the precursor of the second element is precipitated on the carrier. When the temperature is raised to about 300° C. to 500° C. through about 120° C. to 200° C., the second element is supported on the carrier.

Then, the second intermediate may be reduced under a hydrogen atmosphere at a temperature range of about 750° C. to 800° C. to obtain the fuel electrode.

In the hydrogen atmosphere, water vapor and hydrogen gas may be included at a volume ratio of about 3% to 97%.

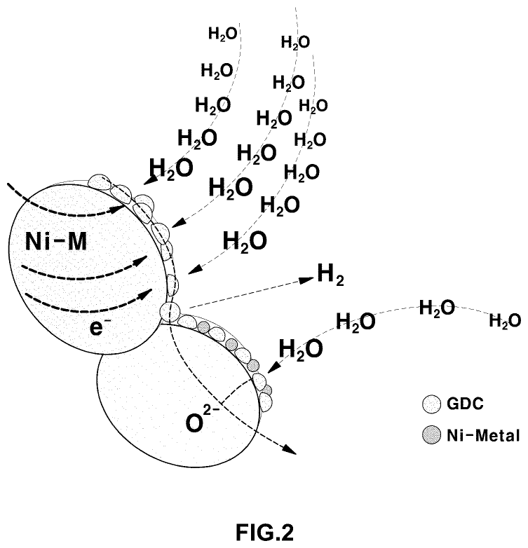

FIG. 2 shows the fuel electrode according to an embodiment of the present disclosure.

The fuel electrode includes the carrier and the catalyst being supported on the carrier.

The carrier includes the first particle containing nickel (Ni) and the second particle containing yttria-stabilized zirconia (YSZ).

The catalyst includes the first element containing at least one selected from the group consisting of Fe, Co, Pd, Cu, Mo, and combinations thereof, and the second element containing gadolinia-doped ceria (GDC).

The catalyst may have a size in a range of about 20 nm to 60 nm.

A portion of the first element forms an alloy with the first particle on a surface of the first particle. The remaining portion of the first element may be supported on the carrier in the form of the particle.

When performing the heat treatment on the second intermediate under a hydrogen atmosphere, nickel oxide (NiO) and the oxide of the first element are reduced to nickel (Ni) and the first element, respectively. As a result, the nickel (Ni) and the first element may form the alloy.

The present disclosure is characterized in that the precursor of the second element is injected after infiltrating the precursor of the first element into the carrier and supporting the same thereon. When injecting the precursor of the second element first, the alloy of the first element and the first particle may not be formed smoothly. In the fuel electrode according to the present disclosure, the first particle and the first element form the alloy, and gadolinia-doped ceria (GDC) has various reactive sites. As a result, electrode resistance is low, and electrolysis efficiency is high.

Hereinafter, the present disclosure will be described in detail with reference to the following Preparation Examples and Experimental Examples. However, the spirit of the present disclosure is not limited thereto.

### Preparation Example 1

A carrier in which nickel oxide (NiO) and yttria-stabilized zirconia (YSZ) were evenly dispersed was prepared.

A first solution was prepared as follows. Fe(NO₃)₃·9H₂O was diluted with distilled water, and urea was added thereto so that a mole ratio of cations to the urea was about 1:10. Then, ethanol was added thereto so that a volume ratio of the distilled water to the ethanol was about 1:3 to produce the first solution.

A second solution was prepared as follows. Ce(NO₃)₂·6H₂O and Gd(NO₃)₃·6H₂O were diluted with distilled water so that a mole ratio of cerium (Ce) to gadolinium (Gd) was about 7:3. Next, urea was added thereto so that a mole ratio of cations to the urea was about 1:10. Then, ethanol was added so that a volume ratio of the distilled water to the ethanol was about 1:3, to produce the second solution.

Next, preheat treatment was performed on the carrier at a temperature of about 400° C.

After performing the preheat treatment, the carrier was sufficiently cooled, and the first solution was added dropwise to the carrier with a micropipette so that the first solution infiltrated into the carrier. Then, a first heat treatment was performed at a temperature of about 80° C. for about 2 hours, at a temperature of about 150° C. for about 1 hour, and at a temperature of about 400° C. for about 2 hours. The first heat treatment was performed one time.

A first intermediate obtained by the first heat treatment was sufficiently cooled, and the second solution was added dropwise to the first intermediate with a micropipette so that the second solution infiltrated into the first intermediate. Then, a second heat treatment was performed at a temperature of about 80° C. for about 2 hours, at a temperature of about 150° C. for about 1 hour, and at a temperature of about 400° C. for about 2 hours. The second heat treatment was performed three times.

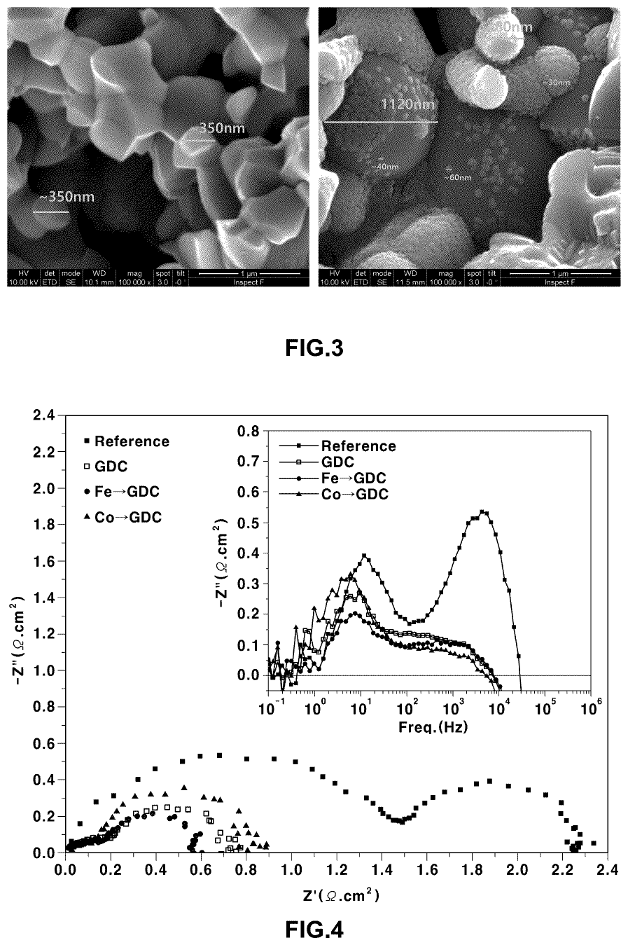

A second intermediate obtained through the second heat treatment was reduced under a hydrogen atmosphere at a temperature of about 800° C. to obtain a fuel electrode. FIG. 3 shows SEM analysis results for the fuel electrode manufactured according to Preparation Example 1. Referring to FIG. 3, it is seen that a catalyst having a diameter in a range of about 20 nm to 60 nm is supported on the first particle (containing Ni) having a size of about 1.5 μm or less and the second particle (containing YSZ) having a size in a range of about 350 nm to 550 nm.

### Preparation Example 2

A fuel electrode was manufactured in the same manner as in Preparation Example 1, except that cobalt nitrate was used as a precursor of a first element.

### Comparative Preparation Example 1

A carrier itself which was not infiltrated with first solution and second solution was set as Comparative Preparation Example 1.

### Comparative Preparation Example 2

A fuel electrode was manufactured in the same manner as in Preparation Example 1, except that the second solution was injected but the first solution was not injected.

### Comparative Preparation Example 3

A fuel electrode was manufactured in the same manner as in Preparation Example 1, except that the second solution was injected and then the first solution was injected. That is, the first solution and the second solution were injected in reversed order to Preparation Example 1.

### Comparative Preparation Example 4

A fuel electrode was manufactured in the same manner as in Preparation Example 1, except that the first solution was injected but the second solution was not injected.

Hereinafter, Preparation Example 1, Preparation Example 2, Comparative Preparation Example 1, Comparative Preparation Example 2, Comparative Preparation Example 3, and Comparative Preparation Example 4 are referred to as Fe-GDC, Co-GDC, reference, GDC, GDC-Fe, and Fe, respectively.

### Experimental Example 1

Polarization resistance of each of the fuel electrodes manufactured according to Preparation Example 1 (Fe-GDC), Preparation Example 2 (Co-GDC), Comparative Preparation Example 1 (Reference), and Comparative Preparation Example 2 (GDC) was measured. The results thereof are shown in FIG. 4. Referring to FIG. 4, it is confirmed that the fuel electrode manufactured according to Preparation Example 1 has the lowest polarization resistance.

Polarization resistance of each of the fuel electrodes manufactured according to Preparation Example 1 (Fe-GDC), Comparative Preparation Example 1 (Reference), Comparative Preparation Example 2 (GDC), and Comparative Preparation Example 3 (GDC-Fe) was measured. The results thereof are shown in Table 1.

TABLE 1

| | Polarization resistance |
|---|---|
| Classification | at a temperature of 700° C. |
| Comparative Preparation | 1.50 |
| Example 1(Reference) | |
| Comparative Preparation | 0.71 |
| Example 2(GDC) | |
| Comparative Preparation | 0.92 |
| Example 3(GDC-Fe) | |
| Preparation Example 1(Fe-GDC) | 0.60 |

Comparing Preparation Example 1 and Comparative Preparation Example 3, the fuel electrode manufactured according to Preparation Example 1 has lower polarization resistance than the fuel electrode manufactured according to Comparative Preparation Example 3. That is, as described in the present disclosure, it is confirmed that the polarization resistance of the fuel electrode is low only when infiltrating the first solution first and then infiltrating the second solution.

### Experimental Example 2

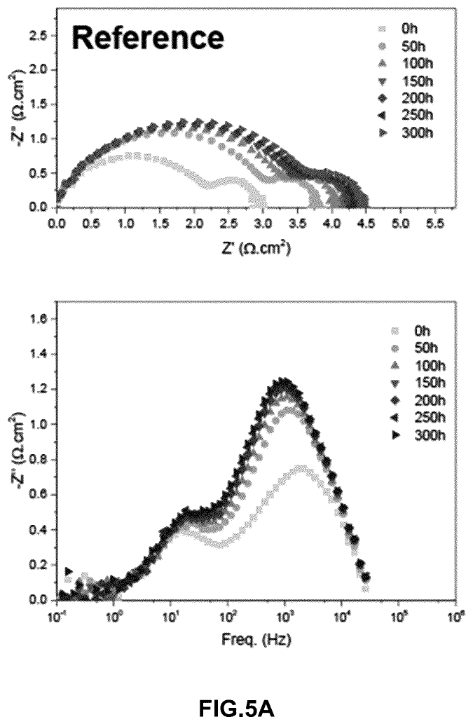

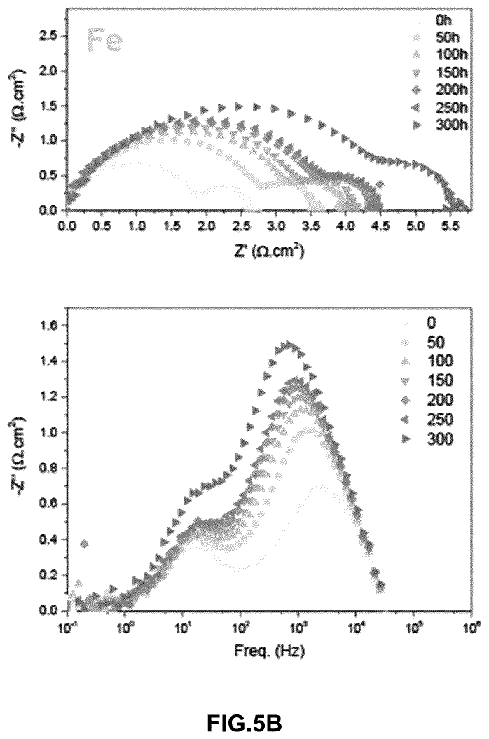

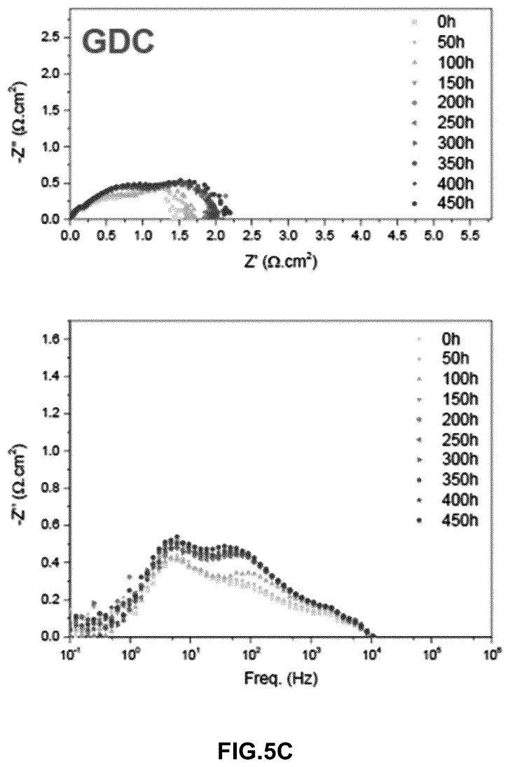

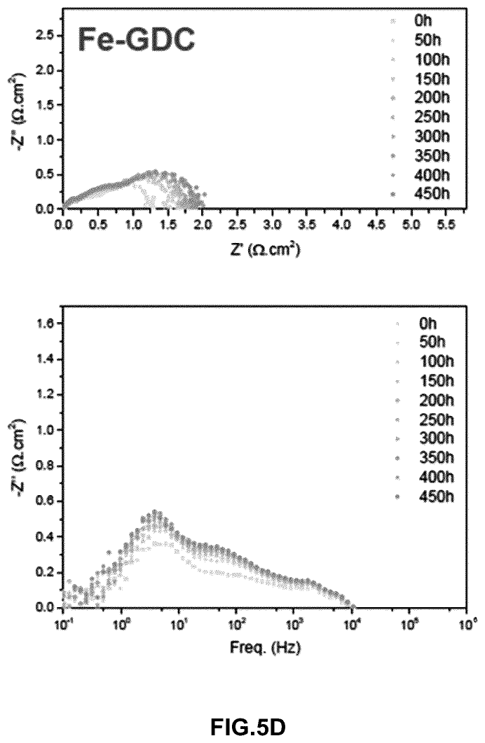

Durability of each of the fuel electrodes manufactured according to Preparation Example 1 (Fe-GDC), Comparative Preparation Example 1 (Reference), Comparative Preparation Example 2 (GDC), and Comparative Preparation Example 4 (Fe) was measured. The results thereof are shown in FIG. 5A to FIG. 5D. Referring to FIG. 5A to FIG. 5D, the fuel electrode manufactured according to Preparation Example 1 exhibited good stability in a high frequency region of 103 Hz to 104 Hz (charge transfer).

### Experimental Example 3

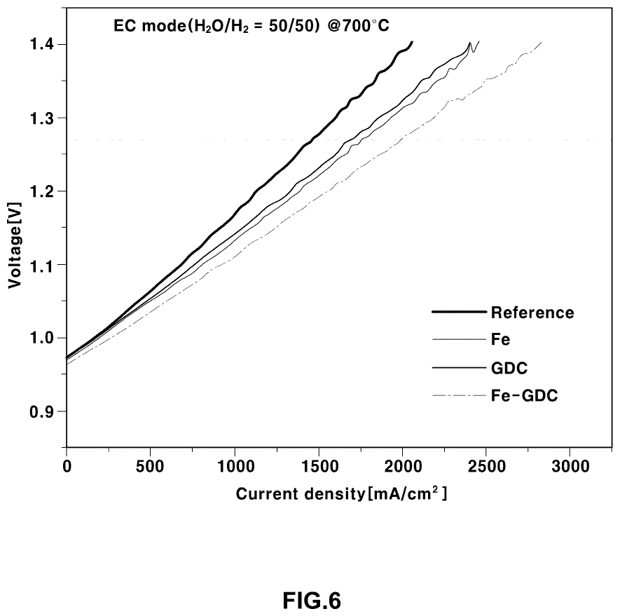

Performance of each of the fuel electrodes manufactured according to Preparation Example 1 (Fe-GDC), Comparative Preparation Example 1 (Reference), Comparative Preparation Example 2 (GDC), and Comparative Preparation Example 4 (Fe) was evaluated. The results thereof are shown in FIG. 6 and Table 2.

TABLE 2

| | Current density at a voltage level of 1.3 V [A/cm²] | | | |
|---|---|---|---|---|
| | Comparative | Comparative | Comparative | |
| | Preparation | Preparation | Preparation | Preparation |
| Temperature | Example 1 | Example 4 | Example 2 | Example 1 |
| [° C.] | (Reference) | (Fe) | (GDC) | (Fe-GDC) |
| 800 | 2.88 at a | 3.64 at a | 3.38 at a | 3.98 at a |
| | voltage level | voltage level | voltage level | voltage level |
| | of 1.2 V | of 1.2 V | of 1.2 V | of 1.2 V |
| 750 | 2.65 | 3.31 | 3.13 | 3.55 |
| 700 | 1.6 | 1.945 | 1.865 | 2.195 |
| 650 | 0.82 | 1.005 | 0.965 | 1.12 |

Referring to FIG. 6 and Table 2, the fuel electrode manufactured according to Preparation Example 1 exhibits the highest current density at all voltages and temperatures, which means, with the application of the same voltage, the higher the current density, the larger the hydrogen production amount. Therefore, it was confirmed that the fuel electrode manufactured according to the present disclosure had the highest efficiency for hydrogen production.

While the present disclosure includes specific examples, it will be apparent after an understanding of the present disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the present disclosure is defined not by the detailed description, but by the claims and their equivalents, and all variations within the scope of the claims and their equivalents are to be construed as being included in the present disclosure.

1. A fuel electrode for a solid oxide electrolysis cell comprising:
a carrier comprising a first particle comprising nickel, and a second particle comprising yttria-stabilized zirconia; and
a catalyst comprising a first element comprising at least one selected from the group consisting of Fe, Co, Pd, Cu, Mo, and combinations thereof, and a second element comprising gadolinia-doped ceria;
wherein the catalyst is supported on the carrier, and at least a portion of the first element forms an alloy with the first particle on a surface of the first particle.

2. The fuel electrode of claim 1, wherein the first particle has a diameter of 1.5 μm or less.

3. The fuel electrode of claim 1, wherein the second particle has a diameter of 350 nm to 500 nm.

4. The fuel electrode of claim 1, wherein the catalyst has a diameter of 20 nm to 60 nm.

5. A method of manufacturing a fuel electrode for a solid oxide electrolysis cell comprising:
preparing a carrier comprising a first particle comprising nickel, and a second particle comprising yttria-stabilized zirconia;
obtaining a first intermediate by injecting a precursor of a first element into the carrier and by performing a first heat treatment, wherein the first element comprises at least one selected from the group consisting of Fe, Co, Pd, Cu, Mo, and combinations thereof;
obtaining a second intermediate by injecting a precursor of a second element into the first intermediate and by performing a second heat treatment, wherein the second element comprises gadolinia-doped ceria; and
obtaining a fuel electrode by reducing the second intermediate under a hydrogen atmosphere;
wherein the fuel electrode comprises a catalyst supported on the carrier,
the catalyst comprises the first element and the second element; and
at least a portion of the first element forms an alloy with the first particle on a surface of the first particle.

6. The method of claim 5, wherein the first particle has a diameter of 1.5 μm or less, and the second particle has a diameter of 350 nm to 500 nm.

7. The method of claim 5, wherein the method further comprises performing heat treatment on the carrier before injecting the precursor of the first element into the carrier.

8. The method of claim 5, wherein the injecting the precursor of the first element into the carrier is that a first solution comprising the precursor of the first element, a chelating agent, and a mixed solvent of a water-based solvent and an alcohol-based solvent is injected into the carrier.

9. The method of claim 8, wherein a mole ratio of cations in the precursor of the first element to the chelating agent is in a range of 1 to 10.

10. The method of claim 8, wherein the chelating agent comprises at least one selected from the group consisting of urea, glycine, Triton X, citric acid, and combinations thereof.

11. The method of claim 8, wherein the precursor of the first element is injected in an amount range of 2.25 mg/cm² to 2.75 mg/cm².

12. The method of claim 5, wherein the first heat treatment is performed by heating at a temperature in a range of 50° C. to 100° C. for 1 hour to 3 hours, in a range of 120° C. to 200° C. for 1 hour to 2 hours, and in a range of 300° C. to 500° C. for 1 hour to 3 hours, and the first heat treatment is performed at least one time.

13. The method of claim 5, wherein the injecting a precursor of a second element into the first intermediate is that a second solution comprising the precursor of the second element, a chelating agent, and a mixed solvent of a water-based solvent and an alcohol-based solvent is injected into the first intermediate.

14. The method of claim 13, wherein a mole ratio of cations in the precursor of the second element to the chelating agent is in a range of 1 to 10.

15. The method of claim 13, wherein the chelating agent comprises at least one selected from the group consisting of urea, glycine, Triton X, citric acid, and combinations thereof.

16. The method of claim 13, wherein the precursor of the second element is injected in an amount range of 81 mg/cm² to 87 mg/cm².

17. The method of claim 5, wherein the second heat treatment is performed by heating at a temperature in a range of 50° C. to 100° C. for 1 hour to 3 hours, in a range of 120° C. to 200° C. for 1 hour to 2 hours, and in a range of 300° C. to 500° C. for 1 hour to 3 hours, and the second heat treatment is performed at least one time.

18. The method of claim 5, wherein the second intermediate is reduced under a hydrogen atmosphere at a temperature range of 750° C. to 800° C. to obtain the fuel electrode.

19. The method of claim 5, wherein the catalyst has a diameter of 20 nm to 60 nm.
